(19) United States
(12) Patent Application Publication
(10) Pub. No.: US 2025/0323254 A1
(43) Pub. Date: Oct. 16, 2025

(54) LITHIATED ELECTRODE MATERIAL, PREPARATION METHOD OF LITHIATED ELECTRODE MATERIAL, AND ELECTRODE

(71) Applicant: National Taiwan University of Science and Technology, TAIPEI CITY (TW)

(72) Inventor: Fu-Ming WANG, New Taipei City (TW)

(21) Appl. No.: 18/985,009

(22) Filed: Dec. 17, 2024

(30) Foreign Application Priority Data
Apr. 10, 2024 (TW) 113113429

(51) Int. Cl. H01M 4/38; C01B 33/113; H01M 4/04; H01M 4/36; H01M 4/583; H01M 4/60

(52) U.S. Cl. CPC H01M 4/386; C01B 33/113; H01M 4/0471; H01M 4/366; H01M 4/583; H01M 4/60

(57) ABSTRACT

The present disclosure provides a lithiated electrode material, a preparation method of the lithiated electrode material, and an electrode. The lithiated electrode material includes an electrode active material and an organic acid lithium salt layer. The organic acid lithium salt layer is coated on the surface of the electrode active material. The organic acid lithium salt layer includes an organic acid lithium salt formed by the lithiation of an organic acid with at least two carboxyl groups. The preparation method of the lithiated electrode material includes mixing the electrode active material, the organic acid lithium salt, and a polar solvent to form the lithiated electrode material. The electrode includes a conductive substrate and a coating layer disposed on the conductive substrate. The coating layer includes the lithiated electrode material, an adhesive, and a conductive material.

### CROSS-REFERENCE TO RELATED APPLICATION

This application claims priority to Taiwan Application Serial Number 113113429, filed Apr. 10, 2024, which is herein incorporated by reference in its entirety.

BACKGROUND

### Field of Invention

The present disclosure relates to a lithiated electrode material, a preparation method of the lithiated electrode material, and an electrode.

### Description of Related Art

Carbon materials such as soft carbon, hard carbon, and graphite are often used as electrode active materials for batteries. However, to pursue higher energy density, silicon-based materials such as silicon or silicon oxide have been tried as the electrode active materials for batteries. Although the silicon-based materials have extremely high energy density, for example, 4000 mAh/g, the silicon-based materials are prone to volume expansion during battery charging and discharging, leading to material rupture. It will eventually lead to poor cycle life and performance of the electrode active materials. Therefore, there is an urgent need to develop other electrode materials to improve the above problems.

### SUMMARY

The present disclosure provides a lithiated electrode material that includes an electrode active material and an organic acid lithium salt layer. The organic acid lithium salt layer is coated on a surface of the electrode active material. The organic acid lithium salt layer includes an organic acid lithium salt, and the organic acid lithium salt is formed by a lithiation of an organic acid with at least two carboxyl groups.

In some embodiments, the electrode active material includes silicon, silicon oxide, soft carbon, hard carbon, graphite, graphene, tin, germanium, or combinations thereof.

In some embodiments, a number average molecular weight of the organic acid lithium salt is 100 to 1000.

In some embodiments, the organic acid with at least two carboxyl groups includes succinic acid, trimesic acid, pyromellitic acid, mellitic acid, diethylenetriaminepentaacetic acid, malonic acid, 1,2,3,4-butanetetracarboxylic acid, citric acid, tartaric acid, tricarballylic acid, phthalic acid, maleic acid, fumaric acid, oxalic acid, or combinations thereof.

The present disclosure provides an electrode including a conductive substrate and a coating layer. The coating layer is disposed on the conductive substrate. The coating layer includes the described lithiated electrode material, an adhesive, and a conductive material.

The present disclosure provides a preparation method of the described lithiated electrode material, and the preparation method includes mixing an electrode active material, an organic acid lithium salt, and a first polar solvent to form the lithiated electrode material. The organic acid lithium salt is formed by a lithiation of an organic acid with at least two carboxyl groups.

In some embodiments, the first polar solvent includes water, methanol, ethanol, acetonitrile, or combinations thereof.

In some embodiments, the electrode active material is 10 parts by weight, and the organic acid lithium salt is 1 part by weight to 4 parts by weight.

In some embodiments, a mixing temperature of mixing the electrode active material, the organic acid lithium salt, and the first polar solvent is 60° C. to 100° C.

In some embodiments, a mixing time of the electrode active material, the organic acid lithium salt, and the first polar solvent is 6 hours to 24 hours.

In some embodiments, the organic acid lithium salt is formed by reacting a lithium salt with the organic acid with at least two carboxyl groups in a second polar solvent.

In some embodiments, the lithium salt includes lithium hydroxide, lithium nitrate, lithium phosphate, lithium sulfate, lithium hexafluorophosphate, lithium tetrafluoroborate, lithium perchlorate, or combinations thereof.

In some embodiments, a molar ratio of the lithium salt to the organic acid with at least two carboxyl groups is between 0.7:1 and 2.5:1.

In some embodiments, a reaction temperature of the lithium salt and the organic acid with at least two carboxyl groups is between 60° C. to 100° C.

In some embodiments, a reaction time of the lithium salt and the organic acid with at least two carboxyl groups is 12 hours to 24 hours.

In some embodiments, the second polar solvent includes water, methanol, ethanol, acetonitrile, or combinations thereof.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings.

FIG. 1 is a schematic cross-sectional view of a lithiated electrode material, in accordance with various embodiments of the present disclosure.

FIG. 2 is a schematic side view of an electrode.

FIGS. 3A-3C illustrate discharge capacity versus cycle number plots, in accordance with some examples of the present disclosure.

FIG. 4A illustrates a discharge capacity versus cycle number plot, in accordance with some examples of the present disclosure.

FIG. 4B illustrates a specific capacity versus cycle number plot, in accordance with some examples of the present disclosure.

FIGS. 5A-5B illustrate electrochemical impedance analysis charts, in accordance with some examples of the present disclosure.

### DETAILED DESCRIPTION

In order to make the description of the present disclosure more detailed and complete, the following provides an illustrative description of the embodiments and specific embodiments of the present disclosure; but this is not the only way to implement or use the specific embodiments of the present disclosure. The various embodiments disclosed below can be combined or replaced with each other under beneficial circumstances, and other embodiments can also be added to some embodiments without further description or explanation.

In this article, the range represented by “one numerical value to another numerical value” is a summary expression that avoids enumerating all the numerical values in the range one by one in the specification. Therefore, the description of a specific numerical range covers any numerical value within the numerical range and the smaller numerical range defined by any numerical value within the numerical range. As if the arbitrary numerical value and the smaller numerical range expressly written in the description are the same.

The present disclosure provides a method for improving a cycle life and a performance of an electrode active material. Specifically, an organic acid lithium salt layer is coated on the electrode active material, in which the organic acid lithium salt layer includes a plurality of lithium ions. A lithium-ion battery may consume some lithium ions during use, and the lithium ions in the organic acid lithium salt layer can supplement the lithium ions during a charging and discharging process of the lithium-ion battery. Thus, the cycle life of the lithium-ion battery is extended, and a rate capability is improved.

The present disclosure provides a method for preparing a lithiated electrode material, and the method includes mixing an electrode active material, an organic acid lithium salt, and a first polar solvent to form the lithiated electrode material. The organic acid lithium salt is formed by a lithiation of an organic acid with at least two carboxyl groups. In some embodiments, the lithiation of the organic acid with at least two carboxyl groups is to react a lithium salt with the organic acid having the at least two carboxyl groups in a second polar solvent.

In some embodiments, the electrode active material is an anode active material. In some embodiments, the electrode active material includes silicon, silicon oxide, soft carbon, hard carbon, graphite, graphene, tin, germanium, or combinations thereof. In some embodiments, the silicon oxide includes silicon monoxide, silicon dioxide, or a combination thereof.

In some embodiments, a number average molecular weight of the organic acid lithium salt is 100 to 1000, such as 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, or 1000. If the number average molecular weight of the organic acid lithium salt is 100 to 1000, a thickness of the lithiated electrode material is moderate and has lower impedance when it is used in the lithium-ion battery.

In some embodiments, the organic acid with at least two carboxyl groups includes succinic acid, trimesic acid, pyromellitic acid, mellitic acid, diethylenetriaminepentaacetic acid, malonic acid, 1,2,3,4-butanetetracarboxylic acid, citric acid, tartaric acid, tricarballylic acid, phthalic acid, maleic acid, fumaric acid, oxalic acid, or combinations thereof.

In some embodiments, mixing the electrode active material, the organic acid lithium salt, and the first polar solvent is performed in a glass reactor, by solid phase, spraying methods.

In some embodiments, the electrode active material is 10 parts by weight, and the organic acid lithium salt is 1 part by weight to 4 parts by weight, such as 1, 1.5, 2, 2.5, 3, 3.5, or 4 part(s) by weight. When the part(s) by weight falls within the above range, an electrode made of the lithiated electrode material can have better battery performance.

In some embodiments, the first polar solvent includes water, methanol, ethanol, acetonitrile, or combinations thereof. In some embodiments, an amount of the first polar solvent is 20 parts by weight to 50 parts by weight, such as 20, 25, 30, 35, 40, 45, or 50 parts by weight.

In some embodiments, a mixing temperature of mixing the electrode active material, the organic acid lithium salt, and the first polar solvent is 60° C. to 100° C., such as 60, 65, 70, 75, 80, 85, 90, 95, or 100° C. If the mixing temperature is 60° C. to 100° C., the organic acid lithium salt is easier to adhere to a surface of the electrode active material, and there is no problem of solvent boiling.

In some embodiments, the first polar solvent is water, and the mixing temperature is 60° C. to 100° C., such as 60, 65, 70, 75, 80, 85, 90, 95, or 100° C. In some embodiments, the first polar solvent is methanol, and the mixing temperature is 60° C. to 65° C., such as 60, 61, 62, 63, 64, or 65° C. In some embodiments, the first polar solvent is ethanol, and the mixing temperature is 60° C. to 77° C., such as 60, 62, 64, 66, 68, 70, 72, 74, 76, or 77° C. In some embodiments, the first polar solvent is acetonitrile, and the mixing temperature is 60° C. to 80° C., such as 60, 62, 64, 66, 68, 70, 72, 74, 76, 78, or 80° C.

In some embodiments, a mixing time of the electrode active material, the organic acid lithium salt, and the first polar solvent is 6 hours to 24 hours, such as 6, 7, 8, 9, 10, 11, 12, 13, 14, 15, 16, 17, 18, 19, 20, 21, 22, 23, or 24 hours. If the mixing time is 6 hours to 24 hours, the organic acid lithium salt is easier to adhere to the surface of the electrode active material.

In some embodiments, the organic acid lithium salt is formed by the lithiation of the organic acid with at least two carboxyl groups with the lithium salt, in which the lithium salt includes lithium hydroxide, lithium nitrate, lithium phosphate, lithium sulfate, lithium hexafluorophosphate, lithium tetrafluoroborate, lithium perchlorate, or combinations thereof. In some embodiments, the organic acid lithium salt includes the organic acid with at least two carboxyl groups in which all carboxyl groups are lithiated, only one carboxyl group is lithiated, two or more carboxyl groups are lithiated, or combinations thereof.

In some embodiments, after mixing the electrode active material, the organic acid lithium salt, and the first polar solvent, the first polar solvent is completely evaporated and then dried to form the lithiated electrode material. In some embodiments, an evaporated temperature and a dried temperature are independently 60° C. to 100° C., such as 60, 65, 70, 75, 80, 85, 90, 95, or 100° C. In some embodiments, a dried time is 3 hours to 12 hours, such as 3, 4, 5, 6, 7, 8, 9, 10, 11, or 12 hours.

In some embodiments, a molar ratio of the lithium salt to the organic acid with at least two carboxyl groups is 0.7-2.5:1, such as 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, or 2.5:1. If the molar ratio of the lithium salt to the organic acid with at least two carboxyl groups is 0.7-2.5:1, the carboxyl groups of the organic acid with at least two carboxyl groups can be substantially replaced by the lithium ions in the lithium salt and there is no problem of excessive lithium salt.

In some embodiments, the molar ratio of the lithium salt with one lithium ion (for example, lithium hydroxide, lithium nitrate, lithium hexafluorophosphate, lithium tetrafluoroborate, lithium perchlorate) to the organic acid with at least two carboxyl groups is 2.1-2.5:1, such as 2.1:1, 2.2:1, 2.3:1, 2.4:1, or 2.5:1. The molar ratio of the lithium salt with two lithium ions (for example, lithium sulfate) to the organic acid with at least two carboxyl groups is 1.05-1.25:1, such as 1.05:1, 1.1:1, 1.15:1, 1.2:1, or 1.25:1. The molar ratio of the lithium salt with three lithium ions (for example, lithium phosphate) to the organic acid with at least two carboxyl groups is 0.7-0.84:1, such as 0.7:1, 0.72:1, 0.74:1, 0.76:1, 0.78:1, 0.8:1, 0.82:1, or 0.84:1.

In some embodiments, a reaction temperature of the lithium salt and the organic acid with at least two carboxyl groups is between 60° C. to 100° C., such as 60, 65, 70, 75, 80, 85, 90, 95, or 100° C. If the reaction temperature is between 60° C. to 100° C., the reactivity is better and there is no problem of solvent boiling.

In some embodiments, a reaction time of the lithium salt and the organic acid with at least two carboxyl groups is 12 hours to 24 hours, such as 12, 13, 14, 15, 16, 17, 18, 19, 20, 21, 22, 23, or 24 hours. If the reaction time is 12 hours to 24 hours, a conversion rate of a displacement reaction is more complete.

In some embodiments, reacting the lithium salt with the organic acid having the at least two carboxyl groups in the second polar solvent is to react the lithium salt with the organic acid having the at least two carboxyl groups in the second polar solvent of 20 parts by weight to 50 parts by weight, such as 20, 25, 30, 35, 40, 45, or 50 parts by weight. In some embodiments, the second polar solvent includes water, methanol, ethanol, acetonitrile, or combinations thereof.

In some embodiments, the lithium salt is reacted with the organic acid having the at least two carboxyl groups in the second polar solvent, followed by drying to obtain the organic acid lithium salt. In some embodiments, a drying temperature is 60° C. to 100° C., such as 60, 65, 70, 75, 80, 85, 90, 95, or 100° C. In some embodiments, a drying time is 6 hours to 24 hours, such as 6, 7, 8, 9, 10, 11, 12, 13, 14, 15, 16, 17, 18, 19, 20, 21, 22, 23, or 24 hours.

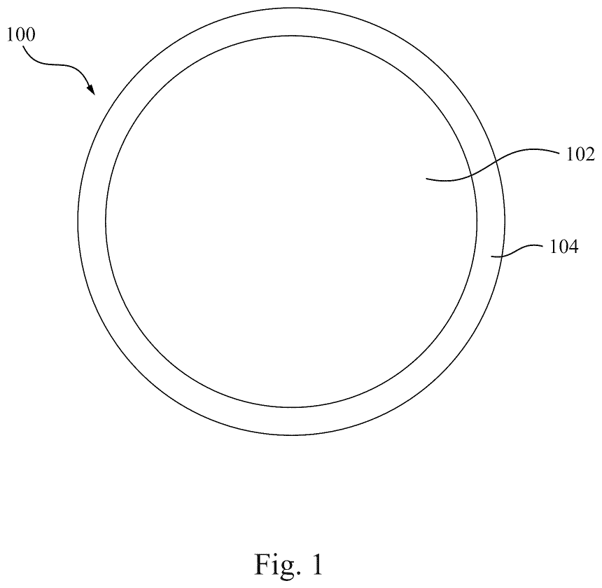

FIG. 1 is a schematic cross-sectional view of a lithiated electrode material 100, in accordance with various embodiments of the present disclosure. As shown in FIG. 1, the present disclosure provides the lithiated electrode material 100 that includes an electrode active material 102 and an organic acid lithium salt layer 104. The organic acid lithium salt layer 104 is coated on a surface of the electrode active material 102. The organic acid lithium salt layer 104 includes the organic acid lithium salt, and the organic acid lithium salt is formed by the lithiation of the organic acid with at least two carboxyl groups. An upper limit of a number of the lithium ions that the organic acid with at least two carboxyl groups can carry after lithiation is a number of the carboxyl groups in the organic acid. That is, the upper limit of the number of the carried lithium ions is at least two. When the organic acid with at least two carboxyl groups carries more lithium ions after lithiation, the cycle life of the lithium-ion battery can be extended and the rate capability is better. The organic acid lithium salt layer 104 is absorbed on the surface of the electrode active material 102 by van der Waals force. Please refer to the above for the embodiments of the electrode active material 102 and the organic acid lithium salt layer 104.

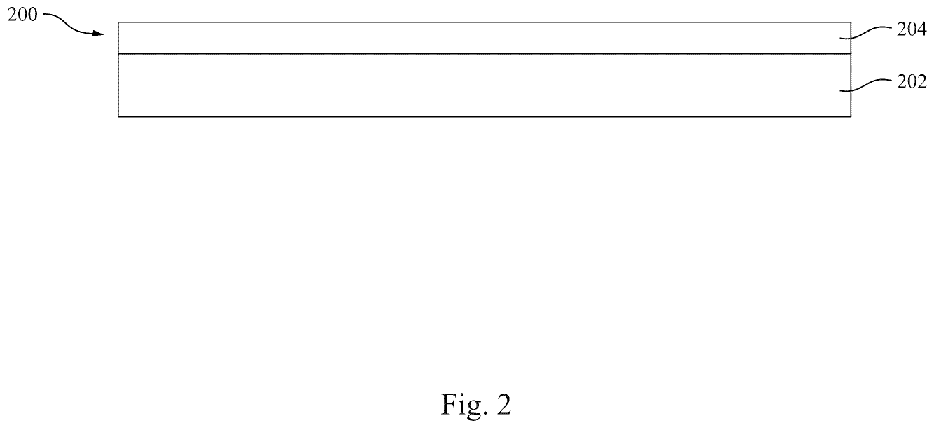

The present disclosure provides an electrode 200. FIG. 2 is a schematic side view of the electrode 200. As shown in FIG. 2, the electrode 200 includes a conductive substrate 202 and a coating layer 204. The coating layer 204 is disposed on the conductive substrate 202. The coating layer 204 includes the lithiated electrode material 100, an adhesive, and a conductive material. In some embodiments, the electrode 200 is an anode used in the lithium-ion battery. Please refer to the above for the embodiments of the lithiated electrode material 100.

In some embodiments, the conductive substrate 202 is a copper foil, a nickel foil, a titanium foil, a stainless steel foil, a tin foil, or an aluminum foil. In some embodiments, the copper foil includes a rolled and annealed copper foil or an electro-deposited copper foil. In some embodiments, the adhesive is a water-based resin, for example, a styrene-butadiene rubber (SBR), carboxymethyl cellulose (CMC), an acrylic resin, or combinations thereof. In some embodiments, the conductive material includes a conductive carbon black, a carbon tube, graphene, graphite, a carbon fiber, or combinations thereof. In some embodiments, the conductive carbon black includes acetylene black, super P carbon black, Ketjen black, or combinations thereof. In some embodiments, the conductive carbon black is spherical or sheet-shaped. In some embodiments, graphite includes artificial graphite, natural graphite, or a combination thereof. In some embodiments, the carbon fiber is vapor grown carbon fibers (VGCF).

In some embodiments, the lithiated electrode material 100 is 60-90 parts by weight, the adhesive is 5-20 parts by weight, and the conductive material is 5-20 parts by weight, in which total parts by weight of the lithiated electrode material 100, the adhesive, and the conductive material is 100. For example, the lithiated electrode material 100 is 60, 65, 70, 75, 80, 85, or 90 parts by weight, the adhesive is 5, 10, 15, or 20 parts by weight, and the conductive material is 5, 10, 15, or 20 parts by weight.

When the electrode 200 is used in a charging and discharging experiment of the lithium-ion battery, the surface of the electrode active material and the organic acid lithium salt layer in the lithiated electrode material is absorbed by van der Waals force. When the electrode 200 is used in the charging and discharging experiment of the lithium-ion battery, the lithium-ion battery may consume a portion of the lithium ions during the charging and discharging process. In the process, the lithium ions in the organic acid lithium salt layer may enter into the electrode active material to supplement the lithium ions consumed by the lithium-ion battery.

The features of the present disclosure will be described in more detail below with reference to experimental examples 1 to 5. Although the following embodiments are described, the materials, the amounts and ratios thereof, the processing details, and the processing procedures, and the like which is used may be appropriately changed without exceeding from the scope of the present disclosure. Therefore, the present disclosure should not be interpreted restrictively by the embodiments described below.

### Experimental Example 1: Preparation of Organic Acid Lithium Salts

In example 1-1, lithium hydroxide and succinic acid at the molar ratio of 2:1 were placed in the glass reactor, 30 ml of water was added in the glass reactor, and the reactants in the glass reactor were reacted at 80° C. for 24 hours, followed by drying at 100° C. for 12 hours to form a lithiated succinic acid.

In example 1-2, lithium hydroxide and trimesic acid at the molar ratio of 2:1 were placed in the glass reactor, 30 ml of water was added in the glass reactor, and the reactants in the glass reactor were reacted at 80° C. for 24 hours, followed by drying at 100° C. for 12 hours to form a lithiated trimesic acid.

In example 1-3, lithium hydroxide and pyromellitic acid at the molar ratio of 2:1 were placed in the glass reactor, 30 ml of water was added in the glass reactor, and the reactants in the glass reactor were reacted at 80° C. for 24 hours, followed by drying at 100° C. for 12 hours to form a lithiated pyromellitic acid.

In example 1-4, lithium hydroxide and mellitic acid at the molar ratio of 2:1 were placed in the glass reactor, 30 ml of water was added in the glass reactor, and the reactants in the glass reactor were reacted at 80° C. for 24 hours, followed by drying at 100° C. for 12 hours to form a lithiated mellitic acid.

In example 1-5, lithium hydroxide and diethylenetriaminepentaacetic acid at the molar ratio of 2:1 were placed in the glass reactor, 30 ml of water was added in the glass reactor, and the reactants in the glass reactor were reacted at 80° C. for 24 hours, followed by drying at 100° C. for 12 hours to form a lithiated diethylenetriaminepentaacetic acid.

### Experimental Example 2: Preparation of Lithiated Anode Materials

In example 2-1, 10 parts by weight of silicon oxide and 1 part by weight of the lithiated succinic acid of the example 1-1 were placed in the glass reactor, 25 mL of water was added in the glass reactor, and the reactants in the glass reactor were reacted at 80° C. for 12 hours, and then after the water is completely evaporated at 100° C., followed by drying for 3 hours to form a lithiated anode material.

In example 2-2, 10 parts by weight of silicon oxide and 1 part by weight of the lithiated trimesic acid of the example 1-2 were placed in the glass reactor, 25 mL of water was added in the glass reactor, and the reactants in the glass reactor were reacted at 80° C. for 12 hours, and then after the water is completely evaporated at 100° C., followed by drying for 3 hours to form a lithiated anode material.

In example 2-3, 10 parts by weight of silicon oxide and 1 part by weight of the lithiated pyromellitic acid of the example 1-3 were placed in the glass reactor, 25 ml of water was added in the glass reactor, and the reactants in the glass reactor were reacted at 80° C. for 12 hours, and then after the water is completely evaporated at 100° C., followed by drying for 3 hours to form a lithiated anode material.

In example 2-4, 10 parts by weight of silicon oxide and 1 part by weight of the lithiated mellitic acid of the example 1-4 were placed in the glass reactor, 25 mL of water was added in the glass reactor, and the reactants in the glass reactor were reacted at 80° C. for 12 hours, and then after the water is completely evaporated at 100° C., followed by drying for 3 hours to form a lithiated anode material.

In example 2-5, 10 parts by weight of silicon oxide and 1 part by weight of the lithiated diethylenetriaminepentaacetic acid of the example 1-5 were placed in the glass reactor, 25 ml of water was added in the glass reactor, and the reactants in the glass reactor were reacted at 80° C. for 12 hours, and then after the water is completely evaporated at 100° C., followed by drying for 3 hours to form a lithiated anode material.

In example 2-6, the lithiated anode material of the example 2-1 was mixed with soft carbon at a weight ratio of 1:9 to form a lithiated anode material.

In example 2-7, the lithiated anode material of the example 2-2 was mixed with soft carbon at a weight ratio of 1:9 to form a lithiated anode material.

In example 2-8, the lithiated anode material of the example 2-3 was mixed with soft carbon at a weight ratio of 1:9 to form a lithiated anode material.

In example 2-9, the lithiated anode material of the example 2-4 was mixed with soft carbon at a weight ratio of 1:9 to form a lithiated anode material.

In example 2-10, the lithiated anode material of the example 2-5 was mixed with soft carbon at a weight ratio of 1:9 to form a lithiated anode material.

The lithiated anode materials of the examples 2-1 to 2-10, the conductive carbon black, and the adhesive were coated on the conductive substrate at a weight ratio of 60:20:20 to make an anode for testing electrical properties.

### Experimental Example 3: Stability Experiments and Reversibility Experiments

In comparative example 3-1, silicon oxide was used as an anode material to make an anode for the stability experiment.

In comparative example 3-2, silicon oxide was used as an anode material to make an anode for the reversibility experiment.

In comparative example 3-3, silicon oxide and soft carbon were mixed at a weight ratio of 1:9 and used as an anode material to make an anode for the stability experiment.

In comparative example 3-4, silicon oxide and soft carbon were mixed at a weight ratio of 1:9 and used as an anode material to make an anode for the reversibility experiment.

In example 3-1, the lithiated anode material of the example 2-1 was made into an anode to conduct the stability experiment.

In example 3-2, the lithiated anode material of the example 2-1 was made into the anode to conduct the reversibility experiment.

In example 3-3, the lithiated anode material of the example 2-5 was made into an anode to conduct the stability experiment.

In example 3-4, the lithiated anode material of the example 2-5 was made into the anode to conduct the reversibility experiment.

In example 3-5, the lithiated anode material of the example 2-4 was made into an anode to conduct the stability experiment.

In example 3-6, the lithiated anode material of the example 2-4 was made into the anode to conduct the reversibility experiment.

In example 3-7, the lithiated anode material of the example 2-9 was made into an anode to conduct the stability experiment.

In example 3-8, the lithiated anode material of the example 2-9 was made into the anode to conduct the reversibility experiment.

In example 3-9, the lithiated anode material of the example 2-7 was made into an anode to conduct the stability experiment.

In example 3-10, the lithiated anode material of the example 2-7 was made into the anode to conduct the reversibility experiment.

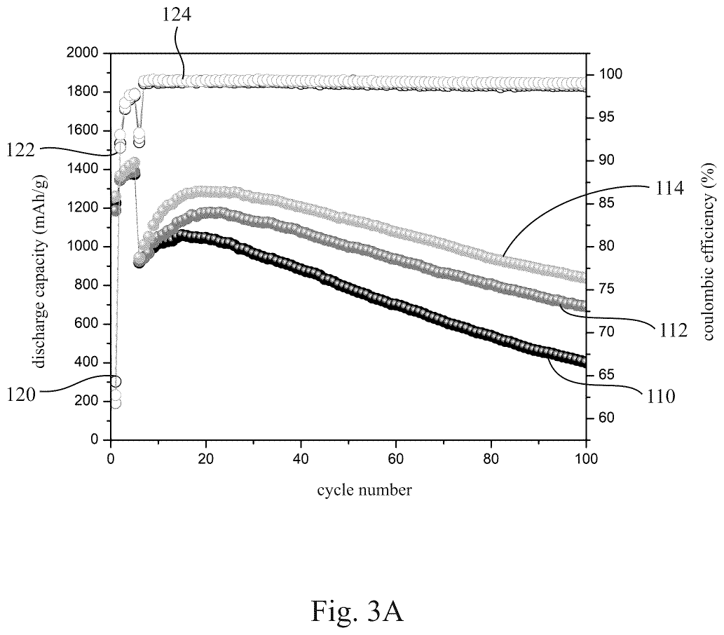

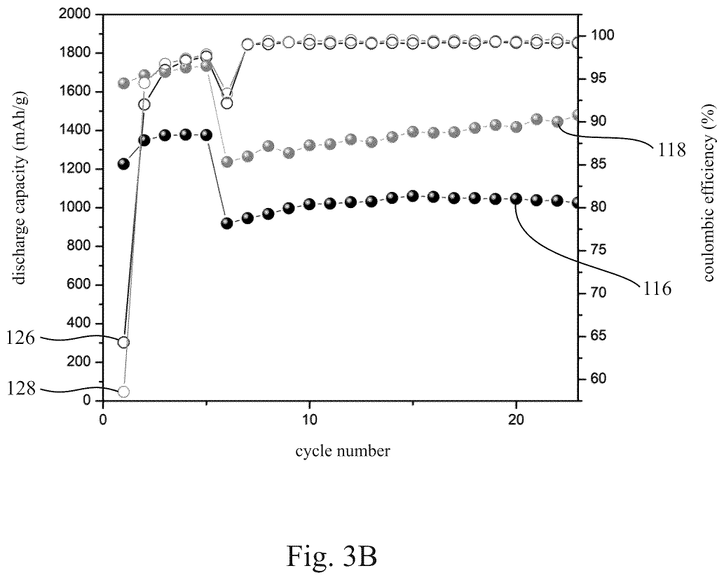

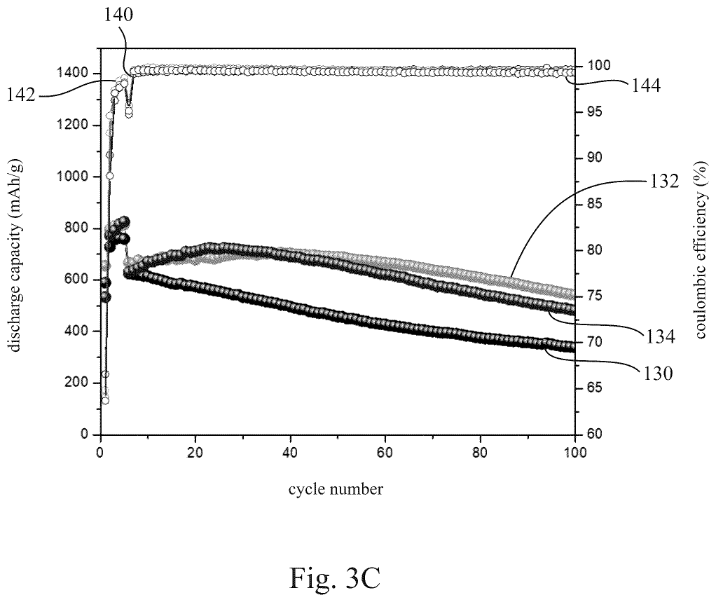

FIGS. 3A-3C illustrate the discharge capacity versus the cycle number plots, in accordance with some examples of the present disclosure. In FIG. 3A, the curve 110 is a stability curve of silicon oxide of the comparative example 3-1 through 100 battery charging and discharging cycles; the curve 112 is a stability curve of the lithiated anode material of the example 2-1 of the example 3-1 through 100 battery charging and discharging cycles; the curve 114 is a stability curve of the lithiated anode material of the example 2-5 of the example 3-3 through 100 battery charging and discharging cycles; the curve 120 is a reversibility curve of silicon oxide of the comparative example 3-2 through 100 battery charging and discharging cycles; the curve 122 is a reversibility curve of the lithiated anode material of the example 2-1 of the example 3-2 through 100 battery charging and discharging cycles; and the curve 124 is a reversibility curve of the lithiated anode material of the example 2-5 of the example 3-4 through 100 battery charging and discharging cycles. The curves 120, 122, and 124 are almost overlapping curves. In FIG. 3B, the curve 116 is a stability curve of silicon oxide of the comparative example 3-1 through 23 battery charging and discharging cycles; the curve 118 is a stability curve of the lithiated anode material of the example 2-4 of the example 3-5 through 23 battery charging and discharging cycles; the curve 126 is a reversibility curve of silicon oxide of the comparative example 3-2 through 23 battery charging and discharging cycles; and the curve 128 is a reversibility curve of the lithiated anode material of the example 2-4 of the example 3-6 through 23 battery charging and discharging cycles. The curves 126 and 128 are almost overlapping curves. In FIG. 3C, the curve 130 is a stability curve of the mixture of silicon oxide and soft carbon of the comparative example 3-3 through 100 battery charging and discharging cycles; the curve 132 is a stability curve of the lithiated anode material of the example 2-9 of the example 3-7 through 100 battery charging and discharging cycles; the curve 134 is a stability curve of the lithiated anode material of the example 2-7 of the example 3-9 through 100 battery charging and discharging cycles; the curve 140 is a reversibility curve of the mixture of silicon oxide and soft carbon of the comparative example 3-4 through 100 battery charging and discharging cycles; the curve 142 is a reversibility curve of the lithiated anode material of the example 2-9 of the example 3-8 through 100 battery charging and discharging cycles; and the curve 144 is a reversibility curve of the lithiated anode material of the example 2-7 of the example 3-10 through 100 battery charging and discharging cycles. The curves 140, 142, and 144 are almost overlapping curves. Same test conditions are used in FIGS. 3A-3C. That is, 0.1 C charging and discharging current was used in 1 to 5 battery charging and discharging cycle(s), and 0.5 C charging and discharging current was used in 6 to 100 battery charging and discharging cycles, in which C is the magnitude of the battery charging and discharging current. 1 C is defined as the magnitude of the current required to discharge the battery capacity for 1 hour, and 0.1 C represents the current required to discharge the battery capacity completely for 10 hours. For example, for a battery with a capacity of 100 mAh, the current of 1 C is 100 mA, and the current of 0.1 C is 10 mA. In FIGS. 3A-3C, the curves of the solid sphere correspond to the vertical axis coordinate of the discharge capacity, and the curves of the hollow sphere correspond to the vertical axis coordinate of the coulombic efficiency, in which the coulombic efficiency is the ratio of the charge capacity to the discharge capacity in the same cycle. Refer to FIGS. 3A-3C. During the 100 battery charging and discharging cycles, the discharge capacities of the curves 112 and 114 is greater than the discharge capacity of the curve 110; the discharge capacity of the curve 118 are greater than the discharge capacity of the curve 116; and the discharge capacities of the curves 132 and 134 are greater than the discharge capacity of the curve 130. In detail, when the anode material is doped with the lithiated organic acid, the discharge capacity of which may be greater than the discharge capacity of the anode material undoped with the lithiated organic acid during the 100 battery charging and discharging cycles. This shows that when the anode material is doped with the lithiated organic acid, since the lithiated organic acid includes a plurality of lithium ions, the lithium ions consumed during the use of the lithium-ion battery can be supplement by the lithiated organic acid during the charging and discharging process of the lithium-ion battery, thereby improving the stability of the lithium-ion battery and extending the cycle life of the battery. Besides, in FIGS. 3A-3C, the coulombic efficiencies of the curves 120, 122, 124, 126, 128, 140, 142, and 144 are all approximately 100%, indicating that the battery has good reversibility.

### Experimental Example 4: Rate Capability Experiments

In comparative example 4-1, silicon oxide was used as the anode material to make the anode for the rate capability experiment.

In comparative example 4-2, silicon oxide and soft carbon were mixed at the weight ratio of 1:9 as the anode material to make the anode for the rate capability experiment.

In example 4-1, the lithiated anode material of the example 2-1 was made into the anode to conduct the rate capability experiment.

In example 4-2, the lithiated anode material of the example 2-5 was made into the anode to conduct the rate capability experiment.

In example 4-3, the lithiated anode material of the example 2-9 was made into the anode to conduct the rate capability experiment.

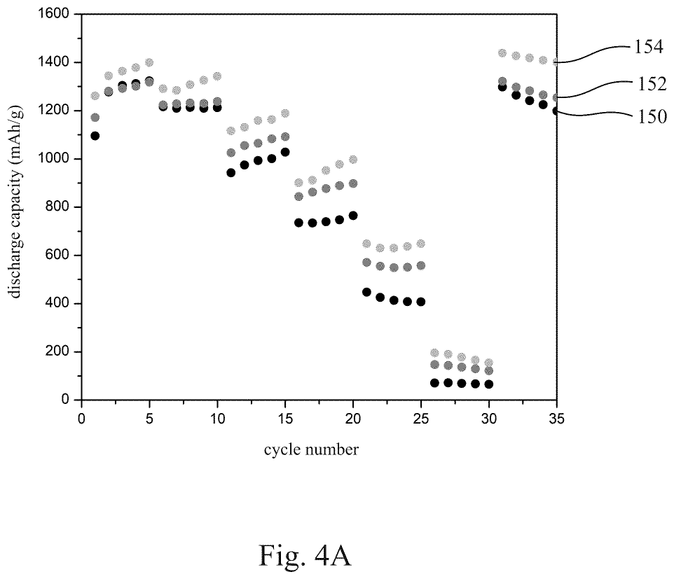

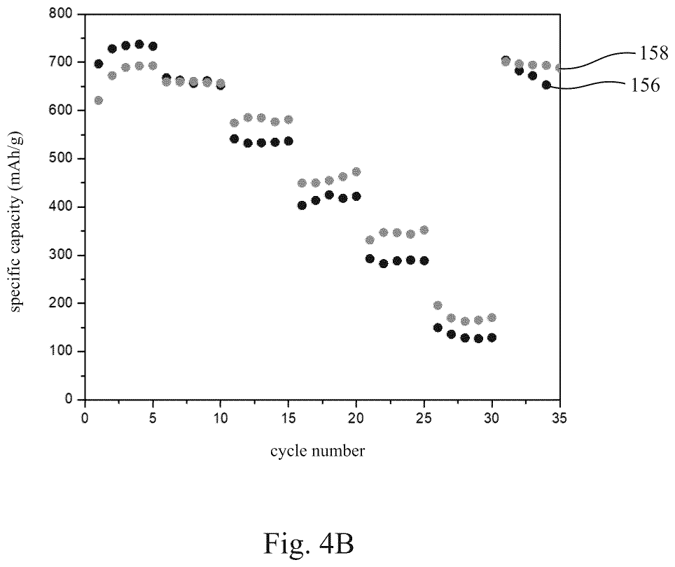

FIG. 4A illustrates the discharge capacity versus the cycle number plot, in accordance with some examples of the present disclosure. FIG. 4B illustrates the specific capacity versus the cycle number plot, in accordance with some examples of the present disclosure. In FIG. 4A, data points 150 are the rate capability of silicon oxide of the comparative example 4-1; data points 152 are the rate capability of the lithiated anode material of the example 2-1 of the example 4-1; and data points 154 are the rate capability of the lithiated anode material of the example 2-5 of the example 4-2. In FIG. 4B, data points 156 are the rate capability of the mixture of silicon oxide and soft carbon of the comparative example 4-2; and data points 158 are the rate capability of the lithiated anode material of the example 2-9 of the example 4-3. Same test conditions are used in FIGS. 4A-4B. That is, 35 battery charging and discharging cycles were used; 0.1 C charging current was used in 1 to 35 battery charging and discharging cycle(s); 0.1 C discharging current was used in 1 to 5 battery charging and discharging cycle(s); 0.2 C discharging current was used in 6 to 10 battery charging and discharging cycles; 0.5 C discharging current was used in 11 to 15 battery charging and discharging cycles; 1 C discharging current was used in 16 to 20 battery charging and discharging cycles; 2 C discharging current was used in 21 to 25 battery charging and discharging cycles; 5 C discharging current was used in 26 to 30 battery charging and discharging cycles; 0.1 C discharging current was used in 31 to 35 battery charging and discharging cycles. Refer to FIGS. 4A-4B. During 35 battery charging and discharging cycles, the discharge capacities of the data points 152 and 154 are greater than the discharge capacities of the data points 150; and the specific capacity of the data points 158 is greater than the specific capacity of the data points 156. In detail, when the anode material is doped with the lithiated organic acid, the discharge capacity and the specific capacity of which may be greater than the discharge capacity and the specific capacity of the anode material undoped with the lithiated organic acid during the 35 battery charging and discharging cycles. This shows that when the anode material is doped with the lithiated organic acid, since the lithiated organic acid includes a plurality of lithium ions, the lithium ions consumed during the use of the lithium-ion battery can be supplement by the lithiated organic acid during the charging and discharging process of the lithium-ion battery, thereby improving the rate capability.

### Experimental Example 5: AC Impedance Experiments

In comparative example 5-1, silicon oxide was used as the anode material to make the anode for the AC impedance experiment.

In comparative example 5-2, silicon oxide and soft carbon were mixed at the weight ratio of 1:9 as the anode material to make the anode for the AC impedance experiment.

In example 5-1, the lithiated anode material of the example 2-1 was made into the anode to conduct the AC impedance experiment.

In example 5-2, the lithiated anode material of the example 2-5 was made into the anode to conduct the AC impedance experiment.

In example 5-3, the lithiated anode material of the example 2-7 was made into the anode to conduct the AC impedance experiment.

In example 5-4, the lithiated anode material of the example 2-9 was made into the anode to conduct the AC impedance experiment.

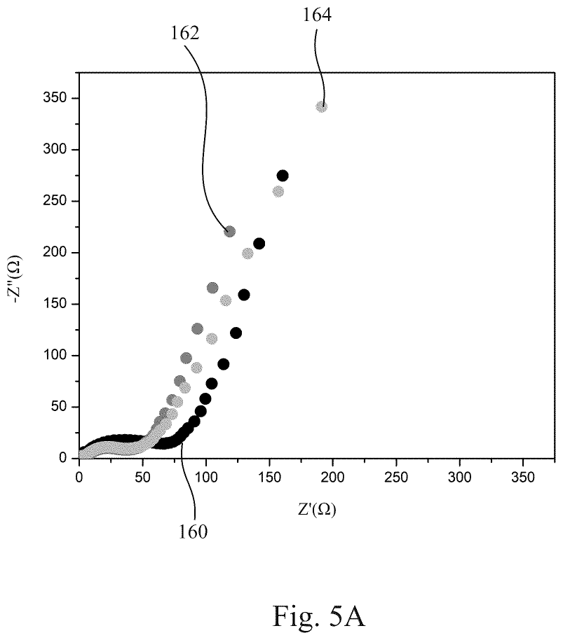

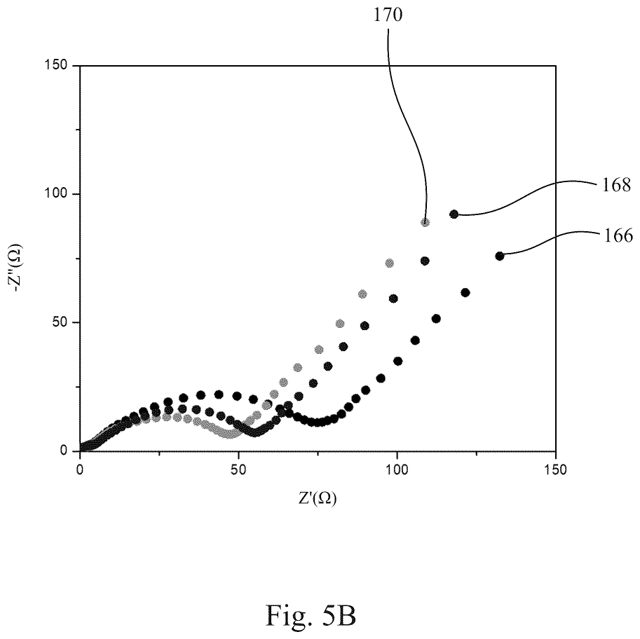

FIGS. 5A-5B illustrate the electrochemical impedance analysis charts, in accordance with some examples of the present disclosure. In FIG. 5A, the data points 160 are AC impedance data points of the silicon oxide of the comparative example 5-1; the data points 162 are AC impedance data points of the lithiated anode material of the example 2-1 of the example 5-1; and the data points 164 are AC impedance data points of the lithiated anode material of the example 2-5 of the example 5-2. In FIG. 5B, data points 166 are AC impedance data points of the mixture of the silicon oxide and soft carbon of the comparative example 5-2; the data points 168 are AC impedance data points of the lithiated anode material of the example 2-7 of the example 5-3; and the data points 170 are AC impedance data points of the lithiated anode material of the example 2-9 of the example 5-4. Same test conditions are used in FIGS. 5A-5B. That is, 100 battery charging and discharging cycles, 0.5 C current, and room temperature. In FIGS. 5A-5B, Z′ is the real part of the AC impedance, and Z″ is the imaginary part of the AC impedance. Refer to FIGS. 5A, 5B, table 1, and table 2. Solid electrolyte interphase resistance (Rₛₑᵢ) of the data points 164 is smaller than the Rₛₑᵢ of the data points 160. Charge transfer resistance (R_{ct}) of the data points 162 and 164 are smaller than the R_{ct} of the data points 160. The Rₛₑᵢ of the data points 170 is smaller than the Rₛₑᵢ of the data points 166; and the R_{ct} of the data points 168 and 170 are smaller than the R_{ct} of the data points 166. In detail, when the anode material is doped with the lithiated organic acid, the Rₛₑᵢ and the R_{ct} of which may be smaller than the Rₛₑᵢ and the R_{ct} of the anode material undoped with the lithiated organic acid. This shows that when the anode material is doped with the lithiated organic acid, since the lithiated organic acid includes a plurality of lithium ions, the lithium ions consumed during the use of the lithium-ion battery can be supplement by the lithiated organic acid during the charging and discharging process of the lithium-ion battery, thereby reducing the AC impedance value.

TABLE 1

| | solid electrolyte | |
|---|---|---|
| | interphase | charge transfer |
| | resistance (Rₛₑᵢ) | resistance (R_{ct}) |
| comparative | 6.45 ohm | 81.28 ohm |
| example 5-1 | | |
| (data points 160) | | |
| example 5-1 | 7.75 ohm | 41.44 ohm |
| (data points 162) | | |
| example 5-2 | 5.95 ohm | 46.16 ohm |
| (data points 164) | | |

TABLE 2

| | solid electrolyte | |
|---|---|---|
| | interphase | charge transfer |
| | resistance (Rₛₑᵢ) | resistance (R_{ct}) |
| comparative | 5.34 ohm | 81.47 ohm |
| example 5-2 | | |
| (data points 166) | | |
| example 5-3 | 6.00 ohm | 57.13 ohm |
| (data points 168) | | |
| example 5-4 | 3.58 ohm | 50.02 ohm |
| (data points 170) | | |

Before and after the battery is charged and discharged, in the anode, the organic acid lithium salt layer in the lithiated anode material is absorbed on the surface of the anode active material by van der Waals force. The lithium-ion battery may consume portions of lithium ions during use. In the charging and discharging process, the lithium ions in the organic acid lithium salt layer may enter into the anode active material to supplement the lithium ions consumed by the lithium-ion battery.

In summary, when the electrode material is doped with the lithiated organic acid, since the lithiated organic acid includes a plurality of lithium ions, the lithium ions consumed during the use of the lithium-ion battery can be supplement by the lithiated organic acid during the charging and discharging process of the lithium-ion battery, thereby making a better stability of the battery, extending the battery cycle life, improving the rate capability, and reducing the AC impedance value.

Although the present disclosure has been described in considerable detail with reference to certain embodiments, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover the modifications and variations of the present disclosure falling within the scope of the appended claims.

What is claimed is:

1. A lithiated electrode material, comprising:
an electrode active material; and
an organic acid lithium salt layer coated on a surface of the electrode active material, wherein the organic acid lithium salt layer comprises an organic acid lithium salt, and the organic acid lithium salt is formed by a lithiation of an organic acid with at least two carboxyl groups.

2. The lithiated electrode material of claim 1, wherein the electrode active material comprises silicon, silicon oxide, soft carbon, hard carbon, graphite, graphene, tin, germanium, or combinations thereof.

3. The lithiated electrode material of claim 1, wherein a number average molecular weight of the organic acid lithium salt is 100 to 1000.

4. The lithiated electrode material of claim 1, wherein the organic acid with at least two carboxyl groups comprises succinic acid, trimesic acid, pyromellitic acid, mellitic acid, diethylenetriaminepentaacetic acid, malonic acid, 1,2,3,4-butanetetracarboxylic acid, citric acid, tartaric acid, tricarballylic acid, phthalic acid, maleic acid, fumaric acid, oxalic acid, or combinations thereof.

5. An electrode, comprising:
a conductive substrate; and
a coating layer disposed on the conductive substrate, the coating layer comprising the lithiated electrode material of claim 1, an adhesive, and a conductive material.

6. A preparation method of a lithiated electrode material, comprising:
mixing an electrode active material, an organic acid lithium salt, and a first polar solvent to form the lithiated electrode material, wherein the organic acid lithium salt is formed by a lithiation of an organic acid with at least two carboxyl groups.

7. The preparation method of claim 6, wherein the first polar solvent comprises water, methanol, ethanol, acetonitrile, or combinations thereof.

8. The preparation method of claim 6, wherein the electrode active material is 10 parts by weight, and the organic acid lithium salt is 1 part by weight to 4 parts by weight.

9. The preparation method of claim 6, wherein a mixing temperature of mixing the electrode active material, the organic acid lithium salt, and the first polar solvent is 60° C. to 100° C.

10. The preparation method of claim 6, wherein a mixing time of the electrode active material, the organic acid lithium salt, and the first polar solvent is 6 hours to 24 hours.

11. The preparation method of claim 6, wherein the organic acid lithium salt is formed by reacting a lithium salt with the organic acid with at least two carboxyl groups in a second polar solvent.

12. The preparation method of claim 11, wherein the lithium salt comprises lithium hydroxide, lithium nitrate, lithium phosphate, lithium sulfate, lithium hexafluorophosphate, lithium tetrafluoroborate, lithium perchlorate, or combinations thereof.

13. The preparation method of claim 11, wherein a molar ratio of the lithium salt to the organic acid with at least two carboxyl groups is between 0.7:1 and 2.5:1.

14. The preparation method of claim 11, wherein a reaction temperature of the lithium salt and the organic acid with at least two carboxyl groups is between 60° C. to 100° C.

15. The preparation method of claim 11, wherein a reaction time of the lithium salt and the organic acid with at least two carboxyl groups is 12 hours to 24 hours.

16. The preparation method of claim 11, wherein the second polar solvent comprises water, methanol, ethanol, acetonitrile, or combinations thereof.
